(19) United States
(12) Patent Application Publication
(10) Pub. No.: US 2025/0032361 A1
(43) Pub. Date: Jan. 30, 2025

(54) DOSING CUPS AND RELATED MEDICINAL FLUID DELIVERY SYSTEMS

(71) Applicant: The Procter & Gamble Company, Cincinnati, OH (US)

(72) Inventor: Rabi EL HASSAN, Batavia, OH (US)

(21) Appl. No.: 18/782,150

(22) Filed: Jul. 24, 2024

Related U.S. Application Data
(60) Provisional application No. 63/515,394, filed on Jul. 25, 2023.

(51) Int. Cl. A61J 7/00

(52) U.S. Cl. CPC A61J 7/0046

(57) ABSTRACT

A dosing cup for delivery of a medicinal fluid, the dosing cup including a base wall, an upper rim, and a side wall, thereby defining a fluid-receiving volume, the dosing cup further including three or more anti-nesting projections that extend from an exterior surface of the side wall, where each of the anti-nesting projections extends from the side wall a distance beyond an inner diameter defined by the upper rim. A medicinal fluid delivery system that includes a bottle and a dosing cup. A plurality of dosing cups arranged in a stack. A method of administering a medicinal fluid that uses a dosing cup.

### FIELD OF THE INVENTION

The present disclosure relates to a dosing cup for delivery of a medicinal fluid, where the dosing cup includes anti-nesting projections. The present disclosure also relates to related medicinal fluid delivery systems, dosing cup arrangements, and methods.

### BACKGROUND OF THE INVENTION

Medicinal fluids may be provided in a bottle that includes a dosing cup for delivery of the proper dosage to a user. During manufacturing, dosing cups may become nested within on another, which may disrupt process flows, as nested dosing cups may interfere with packaging processes, thereby leading to production inefficiencies. Some dosing cups include anti-nesting features, but the features can lead to suboptimal stacking stability and/or inefficient delivery of the medicinal fluid.

Additionally, once the dosage cup is provided to the consumer, often the dosing cup may be difficult to read due to layout, text type, text size, and/or wetting of dosing indicia formed on the interior of the dosing cup.

Accordingly, there is a need for alternative dosing cups and related medicinal fluid delivery systems to address one or more of the above issues.

### SUMMARY OF THE INVENTION

The present disclosure relates to dosing cups that include anti-nesting projections, as well as related arrangements, systems, and methods.

For example, the present disclosure relates to a dosing cup for delivery of a medicinal fluid, the dosing cup including: a base wall, the base wall having a centroid; a longitudinal axis orthogonal to the base wall and extending through the centroid of the base wall; an upper rim located axially away from the base wall and around the longitudinal axis, the upper rim defining an inner diameter of the dosing cup; a side wall extending about the longitudinal axis from the base wall to the upper rim, thereby defining a fluid-receiving volume, the side wall having an interior surface and an exterior surface; and three or more anti-nesting projections that extend from the exterior surface of the side wall, wherein each of the anti-nesting projections extends from the side wall a distance beyond the inner diameter of the upper rim.

The present disclosure also relates to a medicinal fluid delivery system that includes: a bottle, optionally having a closure; and a dosing cup as described herein.

The present disclosure also relates to a plurality of dosing cups according to the present disclosure, where at least a first dosing cup and a second dosing cup are arranged in a stack, such that the anti-nesting projections of one of the first or second dosing cups are in contact with the upper rim of the other dosing cup.

The present disclosure also relates to a method of administering a medicinal fluid, the method including the steps of: providing a dosing cup according to the present disclosure; providing a medicinal fluid to the fluid-receiving volume of the dosing cup, preferably providing a first predetermined volume of the medicinal fluid; and orally administering the medicinal fluid from the dosing cup to a person in need of the medicinal fluid.

### BRIEF DESCRIPTION OF THE DRAWINGS

The figures herein are illustrative in nature and are not intended to be limiting.

FIG. 1 shows a bottom perspective view of a dosing cup according to the present disclosure.

FIG. 2 shows a top perspective view of a dosing cup according to the present disclosure.

FIG. 3 shows a side view of a dosing cup according to the present disclosure.

FIG. 4A shows another side view of a dosing cup according to the present disclosure.

FIG. 4B shows a cross-sectional view of the dosing cup of FIG. 4A from the top, viewed along line 4B-4B.

FIG. 5A shows another side view of a dosing cup according to the present disclosure.

FIG. 5B shows a cross-section view of the dosing cup of FIG. 5A from the side, viewed along line 5B-5B.

FIG. 6 shows a dosing cup according to the present disclosure.

FIG. 7A shows a plurality of dosing cups according to the present disclosure, arranged in a stack.

FIG. 7B shows a cross-sectional view of the stack of dosing cups of FIG. 7A from the side, viewed along line 7B-7B.

FIG. 8A shows an exploded view of a medicinal fluid delivery system according to the present disclosure.

FIG. 8B shows an assembled medicinal fluid delivery system according to the present disclosure.

### DETAILED DESCRIPTION OF THE INVENTION

The present disclosure relates to dosing cups suitable for delivering medicinal fluids, related medicinal fluid delivery systems, and related methods.

The dosing cups of the present disclosure include three or more anti-nesting projections that extend away from the side wall of the cup. The dosing cup may include a total of three anti-nesting projections. A lower edge of each anti-nesting projections may circumferentially extend around the dose cup. The anti-nesting projections, preferably the lower edge of the anti-nesting projections, is designed to contact an upper rim of a second dosing cup when the dosing cup is stacked on or in the second dosing cup, thereby preventing the cups from becoming fully nested.

Without wishing to be bound by theory, it is believed that providing a dosing cup having at least three anti-nesting projections extending from an exterior surface is likely to result in relatively more stable stacks of dosing cups, compared to those made from dosing cups having only two anti-nesting projections. It is believed that (at least) three anti-nesting projections may provide a “tripod” effect and be less prone to wobbling or tipping.

It is further believed that providing a dosing cup with anti-nesting projections with lower edges that extend above a certain minimum length around the circumference of the dosing cup results in relatively stable contact points and results in relatively stable stacks of dosing cups that are less likely to lean or fall over.

It is further believed that providing anti-nesting projections with lower edges that extend less than the full circumference around the dosing cup (e.g., below a certain maximum) results in cups that are relatively easy to separate, due to air passages that that prevent a tight seal and consequent vacuums.

Additionally, it may be advantageous to locate the anti-nesting projections in such a way that the lower edges of the projections indicate a predetermined fill level of the dosing cup. Thus, the lower edges may also serve as volume indicators that are convenient for the user to see so that the medicinal fluid may be properly and accurately dosed.

The dosing cups, related medicinal fluid delivery systems, and related methods of the present disclosure are described in more detail below.

As used herein, the articles “a” and “an” when used in a claim, are understood to mean one or more of what is claimed or described. As used herein, the terms “include,” “includes,” and “including” are meant to be non-limiting. The compositions of the present disclosure can comprise, consist essentially of, or consist of, the components of the present disclosure.

The terms “substantially free of” or “substantially free from” may be used herein. This means that the indicated material is at the very minimum not deliberately added to the composition to form part of it, or, preferably, is not present at analytically detectable levels. It is meant to include compositions whereby the indicated material is present only as an impurity in one of the other materials deliberately included. The indicated material may be present, if at all, at a level of less than 1%, or less than 0.1%, or less than 0.01%, or even 0%, by weight of the composition.

As used herein, the term “dosing cup” refers to a structure used to measure and administer a medicinal fluid.

As used herein, the term “medicinal fluid” may refer to any fluid used for: the relief of symptoms, treatment, and/or prevention of disease, sickness or the like; recovery from disease, sickness, or the like; prevention of disease, sickness, or the like; and/or the provision of dietary supplements. Medicinal fluids may include, but are not limited to, cold and/or flu medicine, headache medicine, gastrointestinal medicine, mouthwash, dietary supplements (including vitamins, minerals, botanical extracts, and the like), etc.

As used herein, the term “removably engaged,” “removably attached,” “removably coupled,” or similar terminology, refers to the ability of the dosing cup to be non-permanently secured to a portion of a container (e.g., a cap and/or closure of a bottle) and removed therefrom in a repeatable fashion.

Unless otherwise noted, all component or composition levels are in reference to the active portion of that component or composition, and are exclusive of impurities, for example, residual solvents or by-products, which may be present in commercially available sources of such components or compositions.

All temperatures herein are in degrees Celsius (C) unless otherwise indicated. Unless otherwise specified, all measurements herein are conducted at 20° C. and under the atmospheric pressure.

In all embodiments of the present disclosure, all percentages are by weight of the total composition, unless specifically stated otherwise. All ratios are weight ratios, unless specifically stated otherwise.

It should be understood that every maximum numerical limitation given throughout this specification includes every lower numerical limitation, as if such lower numerical limitations were expressly written herein. Every minimum numerical limitation given throughout this specification will include every higher numerical limitation, as if such higher numerical limitations were expressly written herein. Every numerical range given throughout this specification will include every narrower numerical range that falls within such broader numerical range, as if such narrower numerical ranges were all expressly written herein.

### Dosing Cups

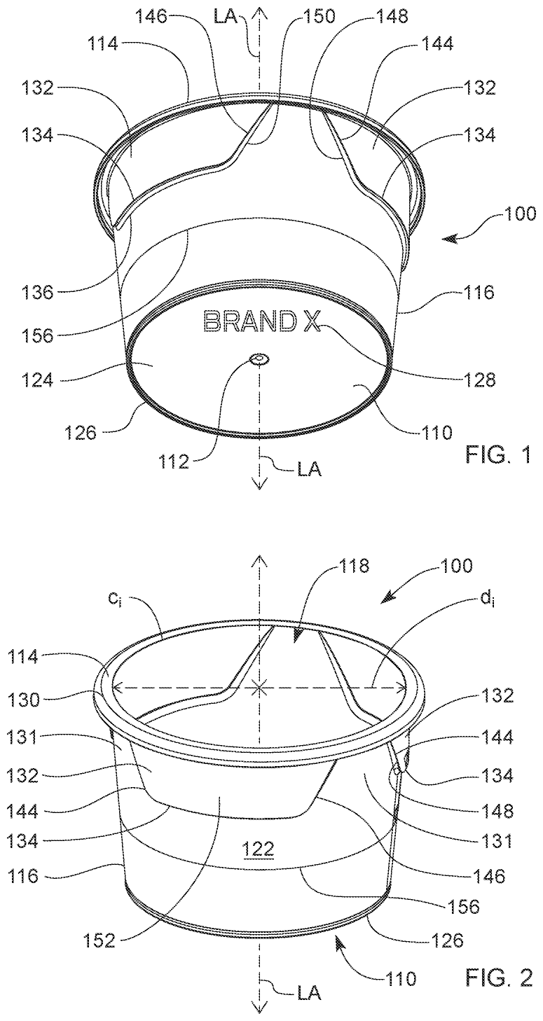

The present disclosure relates to dosing cups. The dosing cups of the present disclosure are useful for measuring and/or administering a dose of medicinal fluid. FIGS. 1-6 show illustrative dosing cups according to the present disclosure.

The dosing cup 100 (or simply “cup” as used herein) may be made of any suitable material. The dosing cup 100 may be made from a plastic material such as polypropylene, preferably clarified polypropylene. The material may be somewhat flexible. The dosing cup 100 may be made from glass, porcelain, polystyrene, or the like. The dosing cup 100 is preferably made of a material that is transparent, translucent, or a combination thereof, as such materials facilitate a user comparing the amount of fluid provided to the dosing cup 100 to volume amount indicators that may be present on the dosing cup 100. The dosing cup 100 is preferably made by an injection molding process; in other words, the dosing cup 100 may be an injection molded dosing cup.

FIGS. 1 and 2 show bottom and top perspective views of a dosing cup 100 according to the present disclosure. The dosing cup 100 generally comprises a base wall 110 at a closed end of the dosing cup 100. The base wall 110 may comprise a centroid 112. The dosing cup 100 comprises a longitudinal axis LA that is orthogonal to the base wall 110 and extends through the centroid 112 of the base wall 110. The dosing cup 100 further comprises an upper rim 114 that is located axially away from the base wall 100 and around the longitudinal axis LA, forming an open end of the dosing cup 100. The dosing cup 100 further comprises a side wall 116 extending about the longitudinal axis LA from the base wall 110 to the upper rim 114, thereby defining a fluid-receiving volume 118. The side wall 116 comprises an interior surface 120 that faces towards the longitudinal axis LA and an exterior surface 122 that faces away from the longitudinal axis LA.

The base wall 110 may generally provide a stable base for the dosing cup 100 to be balanced. For example, the base wall 110 may be stably positioned on a flat surface, such as a tabletop or countertop, to allow a user to pour a medicinal fluid into the fluid-receiving volume 118 of the dosing cup 100.

As shown in FIG. 1, the base wall 110 may include one or more recessed portions 124 such that only a lower rim 126 of the dosing cup 100 may contact a flat surface is positioned thereon. The base wall 110, for example the recessed portion 124, may include a textured surface 128, such as an etched surface. The textured surface 128 may correspond to a product trademark, symbol, logo, and/or manufacturer indicia. The textured surface 128 may have a shape, such as, for example, a circle, oval, a guitar pick, an egg, triangle, a square, a rectangle, or any regular or irregular polygonal or non-polygonal shape. During an injection molding process, formation of the textured surface 128 on the base wall 110 (e.g., on the recessed portion 124) may provide for easier release of the dosing cup 100 from the mold.

The upper rim 114 generally defines the open end of the dosing cup 100, which provides access to the fluid-receiving volume 118. The upper rim 114 may define an inner rim diameter di at the top of the dosing cup 100. The upper rim 114 may define an outer rim diameter do at top of the dosing cup 100. The outer rim diameter do is greater than the inner rim diameter di. The outer rim diameter do may extend beyond the side wall 116 of the dosing cup 100. The upper rim 114 may define an inner rim circumference ci at the top of the dosing cup 100.

The upper rim 114 may comprise a top surface 130 that faces away from the base wall 110. As will be described in more detail below, the anti-nesting projections of one dose cup 100 may contact the top surface 130 of the upper rim 114 of another when the cups are stacked.

The upper rim 114 may extend radially away from the longitudinal axis LA, curve towards the base wall 110, and/or curve towards the side wall 116 of the dosing cup 100, which may provide additional security for one holding the dosing cup 100 and/or a more comfortable interface from which to drink from the dosing cup 100. Such configurations may be known as “rolled rims.” An upper rim 114 having such a configuration (a radially extending portion and/or a portion extending towards the base wall 110, preferably both) may also increase the hoop strength of the dosing cup 100 at the upper rim 114, which can help the dosing cup 100 maintain its designed shape, for example at the time of manufacturing (e.g., from the mold to the production line) or upon repeated use by a user.

The dosing cup 100 may have any suitable size, preferably being able to be picked up by one hand and to receive/dispense a desired amount of medicinal fluid. The dosing cup 100 may have an outer rim diameter, do, of about 40 mm to about 50 mm, preferably about 45 mm. The dosing cup 100 may have an inner rim diameter, di, of about 35 mm to about 45 mm, preferably about 40 mm. The dosing cup 100 may have a height h, which may be from about 20 mm to about 50 mm, preferably from about 25 mm to about 40 mm, even more preferably about 30 mm.

The dosing cup 100 may be generally cylindrical as presently depicted, or it may have alternative prismatic geometric shapes (e.g., triangular, rectangular, pentagonal, hexagonal, octagonal, etc.). Various portions of the sidewall 116 may be sloped, such that a cross-sectional diameter of the sidewall 116 taken near the base wall 110 may be smaller than cross-sectional diameter of the sidewall 116 taken near the upper rim 114. The slope may be gradual or may be interrupted by one or more step outs (e.g., having a “flower pot” shape related to a sudden increase in diameter such that a visual and/or tactile interruption of the interior and/or exterior surfaces 120, 122 is formed).

The dosing cups 100 of the present disclosure comprise three or more anti-nesting projections 132 that extend from the exterior surface 122 of the side wall 116. As indicated above, the anti-nesting projections 132 are configured to prevent undesirable nesting and/or to allow for convenient separation when two or more dosing cups 100 are stacked. Additionally, the anti-nesting projections 132 are sized and configured to provide improved stability when two or more dosing cups 100 are arranged in a stack 104.

The dosing cup 100 may comprise a total of three anti-nesting projections 132 that extend from the exterior surface 122 of the side wall 116. Three anti-nesting projections 132 can provide a “tripod” effect when one dosing cup 100 is stacked on another, providing improved stability compared to dosing cups that have only two areas of anti-nesting projections that are located approximately 180° apart. The dosing cup 100 may comprise an odd number of anti-nesting projections 132, such as three or five, preferably three. The dosing cup 100 preferably comprises three anti-nesting projections 132 spaced circumferentially apart, preferably evenly spaced circumferentially apart (e.g., 120 degrees apart).

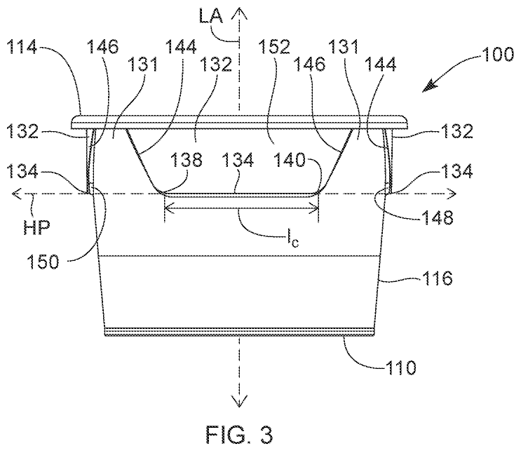

As readily seen in FIGS. 1-3, each of the anti-nesting projections 132 comprises a lower edge 134, which may be located axially away from the upper rim 114 and/or towards the base wall 110. The lower edge 134 of each anti-nesting projection 132 extends from the side wall 116 a distance beyond the inner diameter di of the upper rim 114. Additionally, the lower edges 134 of each anti-nesting projection 132 are substantially in the same horizontal plane HP (see FIG. 3), which is orthogonal to the longitudinal axis LA and substantially parallel to a horizontal plane upon which the base wall 110 can stable rest (e.g., a base plane BP). In view of the described configuration, the lower edge 134 of one dosing cup 100 can stably rest on the upper rim 114, preferably on the top surface 130 of the upper rim 114, of another dosing cup when they are stacked.

The lower edges 134 of the anti-nesting projections 132 can define a horizontal plane HP. It is preferred for the lower edges 134 to be on the same horizontal plane HP in order to cooperate to form a level surface upon which another cup may be stacked. The lower edge 134 of each anti-nesting projection 132 is preferably smooth, substantially circumferentially linear, and continuous, as undulations and/or interruptions may result in less stable contact areas when two or more dosing cups are stacked.

A connecting wall 136 may connect the lower edge 132 of the anti-nesting projection 132 to the side wall 116. The connecting wall 136 may be substantially parallel to the base wall 110. The connecting wall 136 may gentle slope axially downwards from the lower edge 132 to the side wall 116. Depending on the size and configuration of the dosing cups 100 and the anti-nesting projections 132, it may be the connecting wall 136 (optionally in combination with the lower edge 132) of one dosing cup 100 that contacts the upper rim 114 of another when they are stacked.

As shown in FIG. 3, the lower edge 134 of each anti-nesting projection 132 may circumferentially extend a circumferential length l_{c} around the exterior surface 122 of the side wall 116. The circumferential length 1, may be measured as the distance from a first end 138 to a second end 140 of the lower edge 134, where the first and second ends 138, 140 may be defined as the points at which the lower edge 134 ceases to be parallel to a plane upon which the base wall 110 stably sits and/or begins to curve upwards towards the upper rim 114. In order to provide a sufficient contact area to provide the desired stability when two or more dosing cups 100 are stacked, it is preferred that the lower edge(s) 134 extend, in total, a certain minimum fraction of the inner rim circumference ci. Thus, it is preferred that the sum of the circumferential lengths l_{c} of the lower edges 134 of the anti-nesting projections 132 is from about 10% to about 90% of the inner rim circumference ci. The sum of the circumferential lengths 1, of the lower edges 134 is preferably from about 10% to about 70%, more preferably from about 20% to about 60%, even more preferably from about 25% to about 50%, even more preferably from about 35% to about 45%, of the inner rim circumference ci.

The greater the number of anti-nesting projections 132, the relatively less the sum of the circumferential lengths l_{c} of the lower edges 134 may need to be in order to provide the desired stability effects.

As substantially described above, the lower edge 134 of each of the anti-nesting projections 132 may extend circumferentially around the exterior surface 122 of the side wall 116. As mentioned above, each lower edge 134 may have a first end 138 and a second end 140, which may be defined as the points where the lower edge 134 ceases to be parallel to the base wall 110 and/or begins to curve upwards towards the upper rim 114.

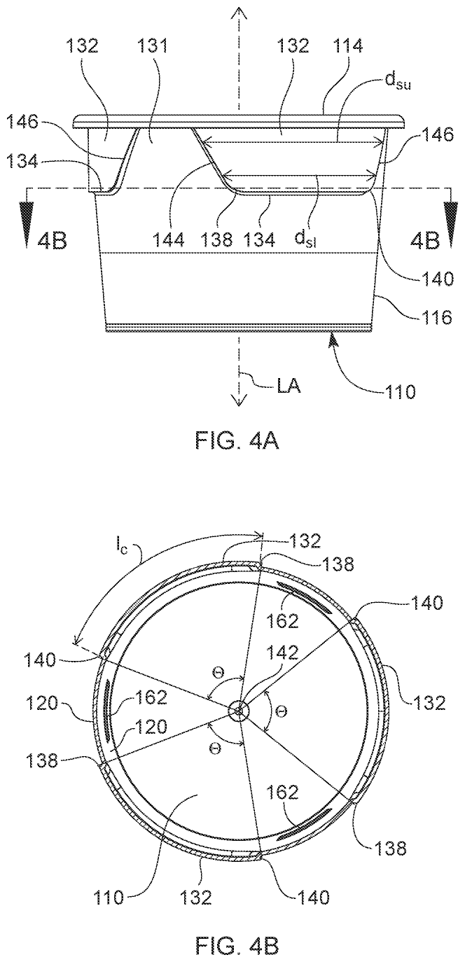

FIG. 4A shows another side view of a dosing cup 100 according to the present disclosure. FIG. 4B shows a cross-sectional view taken at line 4B-4B, viewed from the top of the dosing cup 100. As shown in FIG. 4B, the first end 138 and the second end 140 of the lower edge 134 may define a central angle θ having a vertex 142 on the longitudinal axis LA. The sum of the central angles θ defined by the first and second ends 138, 140 of the lower edges 134 of the anti-nesting projections 132 may be from about 0.1π radians to about 1.9π radians, preferably from about 0.1π radians to about 1.5π radians, more preferably from about 0.2π radians to about 1.2π radians, even more preferably from about 0.5π radians to about 1.0π radians, even more preferably from about 0.7π radians to about 0.9π radians. The greater the number of anti-nesting projections 132, the relatively less the sum of the central angles θ may need to be in order to provide the desired stability effects.

The anti-nesting projections 132 may be symmetrical in shape to each other. The lower edges 134 of the anti-nesting projections 132 may be symmetrical to each other. Symmetrical and/or congruent configurations can result in convenient packaging processes for the manufacturer and/or convenient usage by the user, as the rotational orientation of the dosing cup 100 about the longitudinal axis LA may have little impact.

In addition to having a lower edge 134, each of the anti-nesting projections 132 may further comprise side edges 144, 146 (e.g., a first side edge 144 placed away from a second side edge 146). The side edges 144, 146 may extend from the lower edge 134 towards the upper rim 114. The side edges 144, 146 may connect to the side wall 116 via side connecting walls 148, 150.

The side edges 144, 146 of a given anti-nesting projection 132 may be substantially parallel to each other. Alternatively, the side edges 144, 146 may get relatively closer to each other, or farther apart from each other, as one follows the side edges 144, 146 from the lower edge 134 towards the upper rim 114. The side edges 144, 146 may be substantially straight, or they may have a curve, shape, or other pattern.

The side edges 144, 146 of a given anti-nesting projection 132 may preferably get relatively farther away from each other as one follows them from the lower edge 134 towards the upper rim 114, meaning that the distance between them gets greater the closer one gets to the upper rim 114. Put another way, a distance dₛᵤ between the side edges 144, 146 near the upper rim 114 may be greater than a distance dₛₗ between the side edges 144, 146 near the lower edge 134. Such a configuration can provide a trapezoidal shape to the anti-nesting projection 132, with the shorter parallel side being the lower edge 134 (i.e., an “inverted” trapezoid), as shown in the present figures.

The side wall 116 may comprise one or more non-projecting portions 131 located circumferentially between the anti-nesting projections 132. The one or more non-projecting portions 131 can provide a convenient finger placement location for a user, as the user's fingers can nestle in the “valley” between the anti-nesting projections 132. Providing anti-nesting projections 132 having the “inverted” trapezoidal shape described above and shown in the present figures can be particularly useful, as the side edges 144, 146 of the anti-nesting projections 132 effectively guide a user's fingers towards the upper rim 114, thereby providing a more secure gripping area. Although not shown in the figures, the one or more non-projecting portions 131 may comprise a non-smooth gripping surface, for example, texturing, bumps, or ribs.

The anti-nesting projections 132 may comprise an outer face 152 having a surface that faces away from the longitudinal axis LA. The outer face 152 may be bounded by the lower edge 134 and the side edges 144, 146. The outer face 152 may further be bounded (e.g., at the top) by the upper rim 114 or an area near to it. The outer face 152 may fade into the side wall 116 at a portion of the outer face 152 that is near the upper rim 114 (e.g., at the top). If the outer face 152 does not have a well-defined upper boundary, a suitable boundary can be imagined, for example, as a line that connects the upper ends of the side edges 144, 146 of the anti-nesting projection 132, where the anti-nesting projection meets an underside of the upper rim 114, and/or where the outer face 152 merges with the side wall 116.

The outer face 152 may be characterized as having a shape. The shape may be any suitable shape, for example circular, ovular, elliptical, quadrilateral, or any other suitable convex or concave polygon. The shape of the outer face 152 may preferably be quadrilateral, for example in the shape of a square, a rectangle, or a trapezoid. As described above and as shown in the figures, an “inverted” trapezoid may be particularly preferred for finger placement reasons, where the shorter parallel side (e.g., the lower edge 134) is nearer the base wall 110, and the longer parallel side is nearer the upper rim 114 and may even be substantially defined by the upper rim 114.

The outer face 152 may be characterized by a surface area. The surface area of the outer face 152 may be described relative to a total surface area of the exterior surface 122 of the sidewall 116, inclusive of the anti-nesting projection(s) 132. Additionally, surface area measurements of the outer face(s) 152 may be reported as the surface area for an individual anti-nesting projection 132 or as the combined/sum total surface for all the anti-nesting projections 132 of a dosing cup 100.

For example, the outer face 152 of at least one, preferably each, of the anti-nesting projections 132 may have a surface area that is from about 1% to about 50%, preferably from about 5% to about 25%, of the total surface area of the exterior surface 122 of the sidewall 116, inclusive of the anti-nesting projections 132. The outer face(s) 152 of the anti-nesting projections 132 may have a combined surface area that is from about 2% to about 75%, preferably from about 5% to about 50%, more preferably from about 10% to about 40%, of the total surface area of the exterior surface 122 of the sidewall 116, inclusive of the anti-nesting projections 132.

The outer face 152 of the anti-nesting projection(s) 132 may be at a consistent radial distance relative to the longitudinal axis LA. Put another way, the outer face 152 may be substantially parallel to the longitudinal axis LA (i.e., it is vertically oriented), even though the outer face 152 may wrap circumferentially around the longitudinal axis. A substantially vertical orientation for the anti-nesting projections 132 and/or the outer faces 152 may be preferred when the side wall 116 of the dosing cup 100 are sloped radially inwardly near the base wall 110 compared to the upper rim 114 (i.e., such that a cross-sectional diameter of the sidewall 116 taken near the base wall 110 may be smaller than cross-sectional diameter of the sidewall 116 taken near the upper rim 114), as this configuration can result in the anti-nesting projections 132 extending away from the side wall 116. See, e.g., FIGS. 3, 4A, 5A, and 5B.

Although the present disclosure shows anti-nesting projections 132 having an outer face 152 and a shape (e.g., trapezoidal), it is also contemplated that the anti-nesting projections 132 may have other configurations and still provide the same or similar advantages as those described herein, even if not shown in the present figures. For example, the anti-nesting projections 132 may take the shape of a line or thin ridge that extends circumferentially around the dosing cup 100. The anti-nesting projections 132 may extend minimally in the circumferential direction, for example taking the shape of a dot, bump, bead, peg, or flange that extends away from the side wall 116. For the desired stability of stacking, it would be preferred for such alternate anti-nesting projections 132 to extend the previously described degree around the circumference of the dosing cup 100 and/or to have at least three contact points with a second cup (e.g., to make at least a tripod).

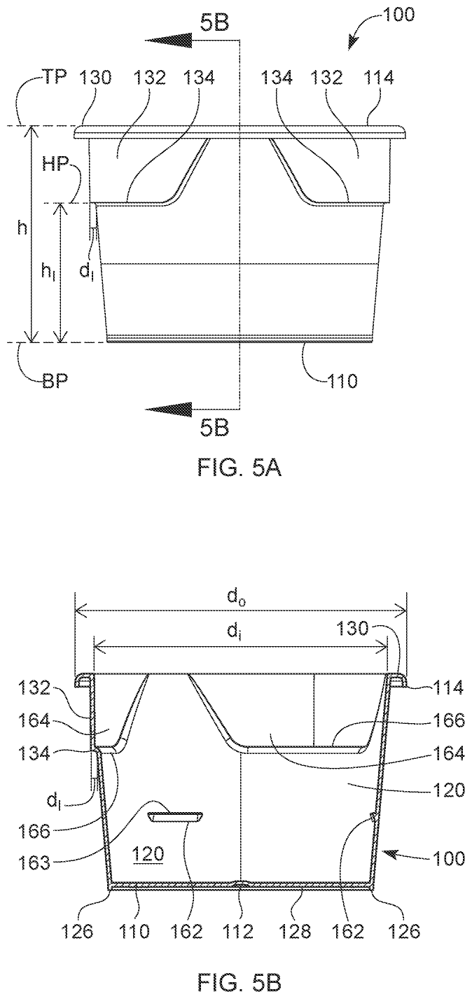

FIG. 5A shows another side view of a dosing cup 100 according to the present disclosure. FIG. 5B shows a side cross-sectional view of a dosing cup 100, viewed along line 5B-5B.

As shown in FIG. 5A, the dosing cup 100 may have a height h, which may be defined as the distance between a top plane TP, defined by the top surface 130 of the upper rim 114, and a base plane BP, defined by the plane upon which the base wall 110 can stably be placed. The dosing cup 100 may have a height h of from about 20 mm to about 50 mm, preferably from about 25 mm to about 40 mm, even more preferably about 30 mm.

The lower edge 134 of the anti-nesting projection 132 is preferably located a fraction of the height h away from the base plane BP, which may be called the ledge height h₁. The ledge height h₁ may be defined as the distance between the base plane BP and the horizontal plane HP defined by the lower edges 134. The ledge height h₁ may be from about 0.4 h to about 0.9 h, preferably from about 0.5 h to about 0.8 h, even more preferably from about 0.6 h to 0. about 8 h, even more preferably from 0.6 h to 0.7 h. The ledge height h₁ may be, as measured from the base plane BP, from about 10 mm to about 30 mm, preferably from about 15 mm to about 25 mm, even more preferably from about 18 mm to about 20 mm. It may be preferred for the anti-nesting projections 132 and the related lower edges 134 to be located in the upper half of the dosing cup 100 (e.g., relatively closer to the upper rim 114) so that more than half of the dosing cup 100 may be seated in a second dosing cup when the cups are arranged in a stack 104, as described below. However, it may also be preferred for the lower edges 134 to be located a sufficient distance away from the upper rim 114 to control for a desired stacking density (e.g., how close together cups are in a stack 104) and/or to provide for a sufficiently large outer face 152 of the anti-nesting projection 132, for example to place indicia, such as volume amount indicators 154, upon.

The lower ledge 134 may extend away from the side wall 116 by a distance di. As substantially described above, the lower ledge 134 should extend beyond the inner rim diameter di so that it can rest upon the upper rim 114 of a second dose cup when the cups are stacked. The distance di may be from about 0.05 mm to about 2 mm, preferably from about 0.1 mm to about 2 mm, more preferably from about 0.2 mm to about 1 mm.

In FIG. 5B, the inner rim diameter di and the outer rim diameter do can readily be seen, as can the top surface 130 of the upper rim 114.

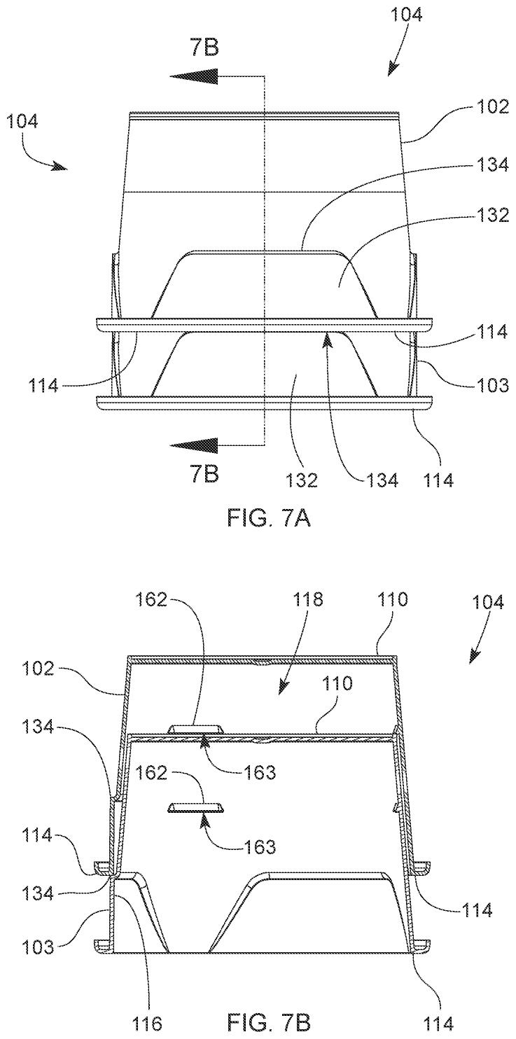

As illustratively seen in FIG. 5B, the dosing cups 100 of the present disclosure may include one or more inner beads 160 located on the interior surface 120 of the side wall 116 and extending towards the longitudinal axis LA. See also FIG. 4B and FIG. 7B. The one or more inner beads 162 may be configured and positioned to contact the base wall 110, for example at least the bottom rim 126, of a second dosing cup that is stacked on the dosing cup 100, thereby providing additional stability and/or support to a stack 101 of such cups. The inner bead 162 may include an upper surface 163 that generally faces in the direction of the upper rim 114 and away from the base wall 110. Preferably the upper surface 163 is flat, thereby providing a stable surface upon which another cup may rest.

Additionally or alternatively, the one or more inner beads 162 may be configured and positioned to contact a bottle, for example the closure of a bottle, that is part of a medicinal fluid delivery system when the dosing cup 100 is inverted and provided to the closure as a removably attachable dosing cup 100; the inner beads 162 can provide friction, helping to retain the dosing cup 100 on the closure and/or facilitating repeated removing and attaching.

It may also be desirable for the interior surface 120 of the side wall 116 to be substantially free of such inner beads 160 or other anti-nesting features, as such features can collect fluid and result in sub-optimal dispensing.

The interior surface 120 of the side wall 116 may comprise a recess 164 that recesses away from the longitudinal axis LA. The recess 164 on the interior surface 120 of the dosing cup 100 typically corresponds to the anti-nesting projection 132 that extends from the exterior surface 122 of the cup 100. The recess 164 may include a shelf 166 that corresponds to the lower edge 134 and/or the connecting wall 136 of the anti-nesting projection 132. The shelf 166 may be parallel to the base wall 110 or may be angled. The shelf 166 can be useful for signaling predetermined volumes to the user. For example, when providing fluid to the dosing cup 100, the user can choose to look at the outside of the cup 100 and observe, e.g., the lower edge 134 of the anti-nesting projection 132 and/or the volume amount indicator 154; alternatively, the user can choose to look at the inside of the cup 100 with confidence that the shelf 166 corresponds to the predetermined volume indicated suggested by the lower edge 134 and/or the volume amount indicator 154.

In addition to the anti-nesting projections 132 to providing anti-nesting benefits, the anti-nesting projections 132 may also be useful for helping with dosing compliance. For example, the dosing cups 100 may be configured such that the lower edges 134 of the anti-nesting projections 132 indicate a predetermined fill-level of the fluid-receiving volume 118, thereby defining a first predetermined volume. It may be preferred that the first predetermined volume is from 1 mL to about 50 mL, more preferably from 2.5 mL to 25 mL, even more preferably from 10 mL to 20 mL. The first predetermined volume may be described as the portion of the fluid-receiving volume 118 that is bound by the base wall 110, the side wall 116, and the horizontal plane HP defined by the lower edges 134 of the anti-nesting projections 132.

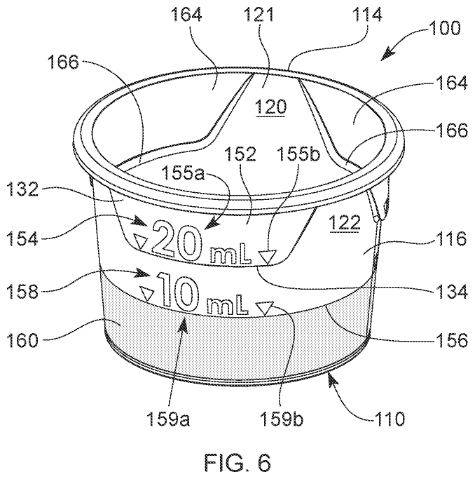

As shown in FIG. 6, the dosing cup 100 may comprise at least one volume amount indicator 154 to aid the user in knowing how much medicinal fluid to dose. As the name implies, the volume amount indicator 154 can signal a predetermined or desirable volume amount to the user. For example, the volume amount indicator 154 may provide the volume amount when the dosing cup 100 is filled to a given level. For example, the volume amount indicator 154 may read 2.5 mL, 5 mL, 10 mL, 15 mL, 20 mL, 25 mL, or any other desired volume. Preferably, the at least one volume amount indicator 154 is positionally coupled with the lower edge 134 of at least one anti-nesting projection 132. Preferably, so that the volume amount indicator 154 can more easily be read by a user during use, the at least one volume amount indicator 154 is located on the exterior surface 122 of the side wall 116 and/or is not located on the interior surface 120 of the side wall 116. The at least one volume amount indicator 154 may be located on the anti-nesting projection 132, preferably on the outer face 152. The at least one volume amount indicator 154 may be printed, molded, or etched onto the dosing cup 100, preferably on the exterior surface 122 of the side wall 116 and/or on the outer face 152 of the anti-nesting projection 132. The dosing cup 100 may comprise more than one volume amount indicator 154 that is associated with a predetermined volume, such as a numerical indication 155a of a volume amount (e.g., “20 mL”) and a symbol 155b (such as an arrow to signify “fill to this line”).

It may be particularly preferred to locate the volume amount indicator 154 on the anti-nesting projection 132, preferably on its outer face 152, when the dosing cup 100 comprises a total of three anti-nesting projections 132. This is because when the three anti-nesting projections 132 are circumferentially spaced apart, the portion 121 of the interior surface 120 of the side wall 116 that is diametrically opposed to a given anti-nesting projection 132 (e.g., on the interior of the opposite side of the cup) is substantially blank, thereby making it easier to read the volume amount indicator 154. This blank portion 121 of the interior surface 116 may be opposite a non-projection portion 131 that may be found on the exterior surface 122 of the side wall 116. This visual benefit may be substantially available when the dosing cup 100 comprises any odd number of (evenly spaced apart) anti-nesting projections 132, but it believed to be particularly advantages when there are three for spacing reasons.

The dosing cup 100 may further comprise an additional volume indicator 156 that indicates a second predetermined fill-level of the fluid-receiving volume 118, thereby defining a second predetermined volume. The additional volume indicator 156 may be located away from the lower edges 134 of the anti-nesting projections 132. The additional volume indicator 156 may be a printed, molded, or etched feature. For example, in FIG. 6, the additional volume indicator 156 is shown as a line that encircles the dosing cup 100. In the figure, the additional volume indicator 156 is relatively lower on the cup 100 (e.g., closer to the base wall 110) than the lower edges 134 of the anti-nesting projections 132, suggesting that the second predetermined volume in this case is less than the first predetermined volume defined by the lower edges 134. The dosing cup 100 may further comprise an additional volume amount indicator 158 that is positionally coupled with the additional volume indicator 156. The additional volume amount indicator 158 typically indicates a volume amount (e.g., “10 mL”) that is different than the (first) volume amount indicated by the (first) volume amount indicator 154 (e.g., “20 mL”). The dosing cup 100 may comprise more than additional sone volume amount indicator 154 that is associated with a second predetermined volume, such as a numerical indication 159a of a volume amount (e.g., “10 mL”) and a symbol 159b (such as an arrow to signify “fill to this line”).

The side wall 116 of the dosing cup 100 may comprise a visually contrasting portion 160 that visually contrasts with other portions of the side wall 116. The visually contrasting portion 160 wraps at least partially, preferably entirely, circumferentially around the dosing cup 100. Preferably the visually contrasting portion 160 is located near the base wall 110. The visually contrasting portion 160 can be useful to help the user with dosing, as the visually contrasting portion 160 can make it easier to see how much fluid has been dispensed into the dosing cup 100, thereby helping with more accurate volume measurements. The visually contrasting portion 160 may be differently colored and/or textured compared to other portions of the side wall 116. Preferably, the side wall 116 is etched (e.g., comprises an etched texture), thereby providing a “frosted” visual impression, to form the visually contrasting portion 160.

### Plurality of Dosing Cups

The present disclosure further relates to a plurality 101 of dosing cups 102, 103, where the dosing cups 102, 103 are as described above, where the plurality 101 comprises at least a first dosing cup 102 and a second dosing cup 103 are arranged in a stack 104 (e.g., along the longitudinal axis LA), such that the anti-nesting projections 132 of one of the first or second dosing cups 102 or 103 are in contact with the upper rim 114 of the other dosing cup 102 or 103.

For example, FIG. 7A shows a plurality 101 of dosing cups 102, 103 arranged in a stack 104. FIG. 7B shows a side cross-sectional view of the stack 104, viewed at line 7B-7B. The dosing cups 102, 103 are identical to each other and are as described herein (e.g., a dosing cup 100 as described above). In the stack 104, a first dosing cup 102 receives a second dosing cup 103 (e.g., the base wall 110 and a portion of the side wall 116 of the second dosing cup 103 is located in the fluid-receiving volume 118 of the first dosing cup 102). The anti-nesting projection 132, specifically the lower edge 134, of the second dosing cup 103 contacts a portion of the upper rim 114 of the first dosing cup 102, thereby preventing the second dosing cup 103 from fully nesting in the first dosing cup 102; the base wall 110 of the second dosing cup 103 is suspended above the base wall 110 of the first dosing cup 102.

When the dosing cups 102, 103 additionally comprise one or more inner beads 162 extending from the interior surface 120, the one or more inner beads 162 may further provide anti-nesting benefits. For example, as shown in the cross-sectional view of FIG. 7B, the first dosing cup 102 comprises an inner bead 162 extending from the interior surface 120. The inner bead 162 may include an upper surface 163 that faces in the direction of the upper rim 114 and away from the base wall 110. When the dosing cups 102, 103 are arranged in a stack 104, the base wall 110 (specifically the bottom rim 126) of the second cup 103 contacts and rests upon the inner bead 162, preferably on the upper surface 163 of the inner bead(s) 162, of the first cup 102. Preferably the upper surface 163 of the inner bead 162 is flat in order to provide a stable surface.

Because the dosing cups 102, 103 are not fully nested in the stack 104, and because the anti-nesting projections 132 of the second cup 103 contact (in total) less than 100% of the upper rim 114 (e.g., makes contact with less than 100% of the inner rim circumference ci of the upper rim 114), it is believed that the dosing cups 102, 103 would be relatively convenient to separate in a packaging process. Furthermore, it is believed that due to the significant contact between the anti-nesting projections 132 of the second cup 103 and the upper rim 114 of the first cup 102 (e.g., at multiple points and/or at a significant fraction of the inner rim circumference ci of the upper rim 114), the stack 104 will be relatively stable.

The stack 104 of the plurality 101 of dosing cups 102, 103 shown in FIGS. 7A and 7B is only an exemplary configuration, and other configurations are contemplated. The stack 104 could include the relative positions of the first and second dosing cups 102, 103 reversed (e.g., where the first dosing cup 102 is placed inside the second dosing cup 103). The stack 104 itself could be inverted (e.g., where the base wall 110 of the dosing cups could be pointed axially downward toward a flat surface such as a tabletop). The plurality 101 of dosing cups 102, 103 arranged in a stack 104 could include any number of dosing cups 100 according to the present disclosure that would be suitable for a packaging process, for example five, ten, twenty, fifty, or one hundred dosing cups 100. After being manufactured, the plurality 101 of dosing cups 102, 103 could be packaged, stored, and/or transported, for example in a box and/or on a pallet, until ready to be used in a packaging process, for example a process that forms a medicinal fluid delivery system 200 as described below.

### Medicinal Fluid Delivery Systems

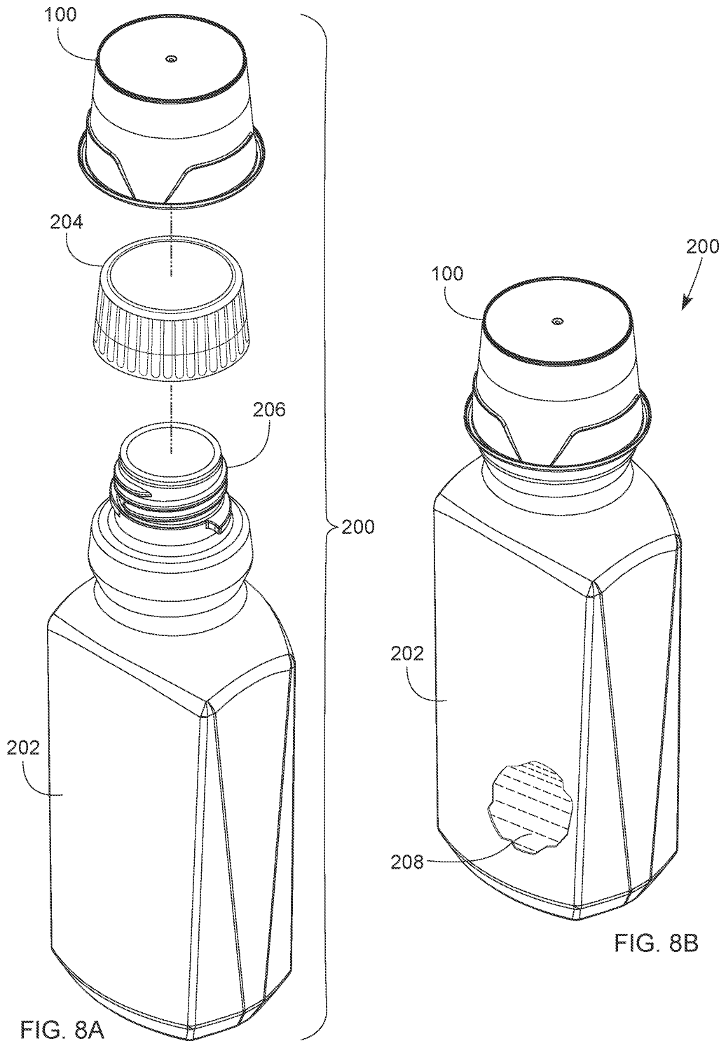

The present disclosure further relates to medicinal fluid delivery systems 200. FIG. 8A shows an exploded view of a medicinal fluid delivery system 200. FIG. 8B shows an assembled medicinal fluid delivery system 200.

As shown in FIG. 8A, the medicinal fluid delivery system 200 may comprise a bottle 202. The bottle may optionally comprise a closure 204. The medicinal fluid delivery system 200 further comprises a dosing cup 100 according to the present disclosure.

The bottle 202 is configured to receive, store, and dispense a medicinal fluid 208. The bottle 202 may comprise a neck 206 that includes an opening through which a medicinal fluid may be dispensed. The bottle 202 may be characterized by any suitable internal volume, such as from about 50 mL to about 1000 mL, preferably from about 100 mL to about 500 mL. The bottle 202 may be made of a transparent, translucent, and/or opaque materials. Transparent and/or translucent materials may be preferred so a remaining volume of the medicinal fluid 208 housed therein can conveniently be assessed. Opaque materials may be preferred, for example, if the medicinal fluid 208 is degradable by light. The bottle 202 may have a color. It may be preferred for the color of the bottle 202 to correspond or substantially match the color of the medicinal fluid 208 housed therein in order to give the user confidence that the proper medicinal fluid 208 is being dispensed.

The closure 204 may be configured to selectively close and seal an open end of the bottle 202. The closure 204 is preferably a threaded cap that can be screwed onto and selectively secured to a neck 206 (e.g., a neck 206 having threads) of the bottle 202.

The dosing cup 100 may be sized and configured to fit over a portion of the bottle 202, preferably the closure 204, as shown in FIG. 8B (where the closure 204 is not visible). The dosing cup 100 may be sized and configured to releasably engage a portion of the bottle 202, preferably the closure 204. For example, as described in more detail above, the dosing cup 100 may comprise one or more inner beads 162 that extend from an interior surface 120 of the side wall 116. When positioned over the bottle 202, the one or more inner beads 162 may allow the dosing cup 100 to be snapped on and off a portion of the bottle 202 to selectively attach the dosing cup 100 to the bottle 202. For example, the one or more inner beads 162 may selectively engage the closure 204.

To further secure the dosing cup 100 to the bottle 202, the medicinal fluid delivery system 200 may further comprise a shrink wrap. The shrink wrap (not shown in the figures) may be arranged around at least a portion of the dosing cup 100 and at least a portion of the bottle 202, thereby securing them together. The shrink wrap can also serve a tamper-evident function, so that the user is alerted to potential tampering if the shrink wrap is damaged or not present upon purchase or the first use of the delivery system 200.

The medicinal fluid delivery system 200 may further comprise a medicinal fluid 208 (shown in a cut-away view in FIG. 8B) housed in an interior volume of the bottle 202. A user may dispense the medicinal fluid 208 by pouring it from the bottle 202 to the dosing cup 100, and then ingest the medicinal fluid 208 by drinking the medicinal fluid from the dosing cup 100. The medicinal fluid 200 may be a digestive aid, a cold/cough aid, a pain relief aid, a sleep aid, an immune system aid, or a combination thereof.

The present disclosure further contemplates methods of assembling medicinal fluid delivery systems 200. The method may include providing a bottle 202, providing a medicinal fluid 208 to the bottle 202, providing a closure 204 to the bottle 202 to effectively seal the bottle 202, providing a dosing cup 100 to the closure 204, and optionally shrink wrapping at least a portion of the medicinal fluid delivery system 200. The method may further include selecting a dosing cup 100 from a plurality 101 of dosing cups. The method may include de-nesting a plurality 101 of dosing cups that are arranged in a stack 104.

### Method of Administering a Medicinal Fluid

The present disclosure further relates to a method of administering a medicinal fluid 208. The method comprises the steps of: providing a dosing cup 100 as described herein; providing a medicinal fluid 208, preferably a predetermined volume of the medicinal fluid 208, to the fluid-receiving volume 118 of the dosing cup 100; and orally administering the medicinal fluid 208 to a person, preferably a person in need of the medicinal fluid 208. The medicinal fluid 208 may start as being housed in a bottle 202, which may be part of a medicinal fluid delivery system 200; the dosing cup 100 may also start as part of the medicinal fluid delivery system 200 and be removed prior to providing the fluid 208 to the cup 100.

The predetermined volume of the medicinal fluid 208 may be a first or second predetermined volume, as described above, and the appropriate volume may be indicated on the dosing cup 100 by the volume amount indicator 154 and/or the additional volume amount indicator 158. The medicinal fluid 208 may be provided to a level even with the lower edge 134 of the anti-nesting projection 132, or to a level even with the additional volume indicator 156. The predetermined volume should be sufficient to deliver a desired amount of the medicinal fluid 208, and/or an active ingredient contained in the medicinal fluid 208, to the person ingesting the medicinal fluid.

The medicinal fluid 208 may be dispensed, for example poured, from a bottle 202 into the dosing cup 100, preferably to a level even with the lower edge 134 of an anti-nesting projection 132 or to an additional volume indicator 156. The volume of medicinal fluid 208 dispensed should be an appropriate amount for the person ingesting it.

### Combinations

Specifically contemplated combinations of the disclosure are herein described in the following lettered paragraphs. These combinations are intended to be illustrative in nature and are not intended to be limiting.

A. A dosing cup for delivery of a medicinal fluid, the dosing cup comprising: a base wall, the base wall comprising a centroid, a longitudinal axis orthogonal to the base wall and extending through the centroid of the base wall, an upper rim located axially away from the base wall and around the longitudinal axis, the upper rim defining an inner diameter of the dosing cup, a side wall extending about the longitudinal axis from the base wall to the upper rim, thereby defining a fluid-receiving volume, the side wall comprising an interior surface and an exterior surface; and three or more anti-nesting projections that extend from the exterior surface of the side wall, wherein each of the anti-nesting projections extends from the side wall a distance beyond the inner diameter of the upper rim.

B. The dosing cup according to paragraph A, wherein each of the anti-nesting projections comprises a lower edge located axially away from the upper rim, wherein the lower edge of each of the anti-nesting projections extends from the side wall a distance beyond the inner diameter of the upper rim.

C. The dosing cup according to paragraph B, wherein the upper rim defines an inner rim circumference, wherein the lower edge of each of the anti-nesting projections circumferentially extends a circumferential length around the exterior surface of the side wall, and wherein the sum of the circumferential lengths of the lower edges of the anti-nesting projections is from about 10% to about 90% of the inner rim circumference, preferably from about 10% to about 70%, more preferably from about 20% to about 60%, even more preferably from about 25% to about 50%, even more preferably from about 35% to about 45%, of the inner rim circumference.

D. The dosing cup according to any of paragraphs B or C, wherein the lower edge of each of the anti-nesting projections extends circumferentially around the exterior surface of the side wall, wherein each lower edge has a first end and a second end that defines a central angle θ having a vertex on the longitudinal axis, wherein the sum of the central angles defined by the first and second ends of the lower edges of the one or more anti-nesting projections is from about 0.1π radians to about 1.9 radians, preferably from about 0.1π radians to about 1.5π radians, more preferably from about 0.2π radians to about 1.2π radians, even more preferably from about 0.5π radians to about 1.0π radians, even more preferably from about 0.7π radians to about 0.9π radians.

E. The dosing cup according to any of paragraphs B-D, wherein the lower edges of the anti-nesting projections define a horizontal plane.

F. The dosing cup according to any of paragraphs A-E, wherein the anti-nesting projections are symmetrical in shape to each other.

G. The dosing cup according to any of paragraphs A-F, wherein the dosing cup comprises a total of three anti-nesting projections spaced circumferentially apart.

H. The dosing cup according to any of paragraphs A-G, wherein each of the anti-nesting projections comprises side edges extending from the lower edge towards the upper rim, preferably wherein a distance between the side edges of an anti-nesting projection near the upper rim is greater than a distance between the side edges near a lower edge of the anti-nesting projection.

I. The dosing cup according to any of paragraphs A-H, wherein each of the anti-nesting projections comprises an outer face that faces away from the longitudinal axis, preferably wherein at least one of the following is true: (a) the outer face of each anti-nesting projection has a surface area that is from about 1% to about 50%, preferably from about 5% to about 25%, of the total surface area of the exterior surface of the sidewall, inclusive of the anti-nesting projections; and/or (b) the three or more anti-nesting projections have a sum total surface area that is from about 2% to about 75%, preferably from about 5% to about 50%, more preferably from about 10% to about 40%, of the total surface area of the exterior surface of the sidewall, inclusive of the anti-nesting projections.

J. The dosing cup according to any of paragraphs A-I, wherein the side wall comprises non-projecting portions located circumferentially between the anti-nesting projections.

K. The dosing cup according to any of paragraphs A-J, wherein the lower edges of the anti-nesting projections indicate a predetermined fill-level of the fluid-receiving volume, thereby defining a first predetermined volume, preferably wherein the first predetermined volume is from 1 mL to about 50 mL, more preferably from 2.5 mL to 25 mL, even more preferably from 10 mL to 20 mL.

L. The dosing cup according to any of paragraphs A-K, wherein the dosing cup comprises at least one volume amount indicator, preferably wherein the at least one volume amount indicator is positionally coupled with the lower edge of at least one anti-nesting projection, more preferably wherein the at least one volume amount indicator is located on the exterior surface of the side wall and/or on the outer face of the one or more anti-nesting projections, preferably on the outer face.

M. The dosing cup according to any of paragraphs A-L, wherein the dosing cup further comprises an additional volume indicator that indicates a second predetermined fill-level of the fluid-receiving volume, thereby defining a second predetermined volume, preferably wherein the dosing cup further comprises an additional volume amount indicator that is positionally coupled with the additional volume indicator.

N. The dosing cup according to any of paragraphs A-M, wherein the side wall of the dosing cup comprises a visually contrasting portion that wraps circumferentially around the dosing cup, preferably wherein the visually contrasting portion is located near the base wall, more preferably wherein the sidewall is colored and/or textured to form the visually contrasting portion, more preferably wherein the sidewall is etched to form the visually contrasting portion.

O. The dosing cup according to any of paragraphs A-N, wherein the dosing cup further comprises one or more inner beads located on the interior surface of the side wall and extending towards the longitudinal axis, preferably wherein the one or more inner beads are positioned to contact the base wall of a second dosing cup that is stacked on the dosing cup.

P. The dosing cup according to any of paragraphs A-O, wherein the dosing cup is made of a material that is transparent, translucent, or a combination thereof.

Q. The dosing cup according to any of paragraphs A-P, wherein the dosing cup comprises a plastic material, preferably polypropylene.

R. The dosing cup according to any of paragraphs A-Q, wherein the dosing cup is made by an injection molding process.

S. A medicinal fluid delivery system comprising: a bottle, optionally comprising a closure; and a dosing cup according to any of paragraphs A-R.

T. A plurality of dosing cups, wherein each dosing cup is according to any of paragraphs A-R, wherein at least a first dosing cup and a second dosing cup are arranged in a stack, such that the anti-nesting projections of one of the first or second dosing cups are in contact with the upper rim of the other dosing cup.

U. A method of administering a medicinal fluid, the method comprising: providing a dosing cup according to any of paragraphs A-R, providing a medicinal fluid to the fluid-receiving volume of the dosing cup, preferably providing a first predetermined volume of the medicinal fluid, and orally administering the medicinal fluid from the dosing cup to a person in need of the medicinal fluid.

The dimensions and values disclosed herein are not to be understood as being strictly limited to the exact numerical values recited. Instead, unless otherwise specified, each such dimension is intended to mean both the recited value and a functionally equivalent range surrounding that value. For example, a dimension disclosed as “40 mm” is intended to mean “about 40 mm.”

Every document cited herein, including any cross referenced or related patent or application and any patent application or patent to which this application claims priority or benefit thereof, is hereby incorporated herein by reference in its entirety unless expressly excluded or otherwise limited. The citation of any document is not an admission that it is prior art with respect to any invention disclosed or claimed herein or that it alone, or in any combination with any other reference or references, teaches, suggests or discloses any such invention. Further, to the extent that any meaning or definition of a term in this document conflicts with any meaning or definition of the same term in a document incorporated by reference, the meaning or definition assigned to that term in this document shall govern.

While particular embodiments of the present invention have been illustrated and described, it would be obvious to those skilled in the art that various other changes and modifications can be made without departing from the spirit and scope of the invention. It is therefore intended to cover in the appended claims all such changes and modifications that are within the scope of this invention.

What is claimed is:

1. A dosing cup for delivery of a medicinal fluid, the dosing cup comprising:
a base wall, the base wall comprising a centroid;
a longitudinal axis orthogonal to the base wall and extending through the centroid of the base wall;
an upper rim located axially away from the base wall and around the longitudinal axis, the upper rim defining an inner diameter of the dosing cup;
a side wall extending about the longitudinal axis from the base wall to the upper rim, thereby defining a fluid-receiving volume,
the side wall comprising an interior surface and an exterior surface; and
three or more anti-nesting projections that extend from the exterior surface of the side wall,
wherein each of the anti-nesting projections extends from the side wall a distance beyond the inner diameter of the upper rim.

2. The dosing cup according to claim 1, wherein each of the anti-nesting projections comprises a lower edge located axially away from the upper rim,
wherein the lower edge of each of the anti-nesting projections extends from the side wall a distance beyond the inner diameter of the upper rim.

3. The dosing cup according to claim 2,
wherein the upper rim defines an inner rim circumference,
wherein the lower edge of each of the anti-nesting projections circumferentially extends a circumferential length around the exterior surface of the side wall, and
wherein the sum of the circumferential lengths of the lower edges of the anti-nesting projections is from about 10% to about 90% of the inner rim circumference.

4. The dosing cup according to claim 2, wherein the lower edge of each of the anti-nesting projections extends circumferentially around the exterior surface of the side wall,
wherein each lower edge has a first end and a second end that defines a central angle θ having a vertex on the longitudinal axis,
wherein the sum of the central angles defined by the first and second ends of the lower edges of the one or more anti-nesting projections is from about 0.1π radians to about 1.9π radians.

5. The dosing cup according to claim 2,
wherein the lower edges of the anti-nesting projections define a horizontal plane.

6. The dosing cup according to claim 1, wherein the anti-nesting projections are symmetrical in shape to each other.

7. The dosing cup according to claim 1, wherein the dosing cup comprises a total of three anti-nesting projections spaced circumferentially apart.

8. The dosing cup according to claim 1, wherein each of the anti-nesting projections comprises side edges extending from the lower edge towards the upper rim.

9. The dosing cup according to claim 1, wherein each of the anti-nesting projections comprises an outer face that faces away from the longitudinal axis,
optionally wherein at least one of the following is true:
(a) the outer face of each anti-nesting projection has a surface area that is from about 1% to about 50% of the total surface area of the exterior surface of the sidewall, inclusive of the anti-nesting projections; and/or
(b) the three or more anti-nesting projections have a sum total surface area that is from about 2% to about 75% of the total surface area of the exterior surface of the sidewall, inclusive of the anti-nesting projections.

10. The dosing cup according to claim 1, wherein the side wall comprises non-projecting portions located circumferentially between the anti-nesting projections.

11. The dosing cup according to claim 1, wherein the lower edges of the anti-nesting projections indicate a predetermined fill-level of the fluid-receiving volume, thereby defining a first predetermined volume,
wherein the first predetermined volume is from 1 mL to about 50 mL.

12. The dosing cup according to claim 1, wherein the dosing cup comprises at least one volume amount indicator,
wherein the at least one volume amount indicator is positionally coupled with the lower edge of at least one anti-nesting projection.

13. The dosing cup according to claim 12, wherein the dosing cup further comprises an additional volume indicator that indicates a second predetermined fill-level of the fluid-receiving volume, thereby defining a second predetermined volume.

14. The dosing cup according to claim 1, wherein the side wall of the dosing cup comprises a visually contrasting portion that wraps circumferentially around the dosing cup.

15. The dosing cup according to claim 1, wherein the dosing cup further comprises one or more inner beads located on the interior surface of the side wall and extending towards the longitudinal axis.

16. The dosing cup according to claim 1, wherein the dosing cup is made of a material that is transparent, translucent, or a combination thereof.

17. The dosing cup according to claim 1, wherein the dosing cup comprises polypropylene.

18. The dosing cup according to claim 1, wherein the dosing cup is made by an injection molding process.

19. A medicinal fluid delivery system comprising:
a bottle, optionally comprising a closure; and
a dosing cup according to claim 1.

20. A method of administering a medicinal fluid, the method comprising:
providing a dosing cup according to claim 1;
providing a medicinal fluid to the fluid-receiving volume of the dosing cup; and
orally administering the medicinal fluid from the dosing cup to a person in need of the medicinal fluid.
